(19) United States
(12) Patent Application Publication
(10) Pub. No.: US 2010/0128269 A1
(43) Pub. Date: May 27, 2010

(54) MINIATURIZED SURFACE PLASMON RESONANCE IMAGING SYSTEM

(75) Inventors: Timothy M. Chinowsky, Seattle, WA (US); Kyle S. Johnston, Kirkland, WA (US); Michael S. Grow, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: UNIVERSITY OF WASHINGTON, Seattle, WA (US)

(21) Appl. No.: 12/304,986

(22) PCT Filed: Jun. 18, 2007
(86) PCT No.: PCT/US07/71471

§ 371 Date: Jan. 28, 2010

Related U.S. Application Data
(60) Provisional application No. 60/814,253, filed on Jun. 16, 2006.

(51) Int. Cl. G01N 21/55; G01J 4/00; G06K 9/00

(52) U.S. Cl. 356/369; 356/445; 382/100

(57) ABSTRACT

A miniaturized Surface Plasmon Resonance (SPR) imaging system (20) is provided, which includes a light source (21), a sensor substrate (26c) arranged to receive light at an incident angle from the light source, and a detector (31) for detecting an image from the sensor substrate. The system further includes a folded light path structure (23) arranged between the light source and the detector. The folded light path structure includes the sensor substrate (26c), and is configured so as to receive the light from the light source, to redirect the received light to be incident on the sensor substrate (26c) at the incident angle (first redirection), and to further redirect the light reflected from the sensor substrate (26c) toward the detector (second redirection). The folded light path structure allows for a minimal instrumentation footprint, which in turn allows for the construction of a miniaturized, hand-portable SPR imaging system.

### CROSS-REFERENCE(S) TO RELATED APPLICATION(S)

This application claims the benefit of U.S. Provisional Application No. 60/814,253, filed Jun. 16, 2006, which is hereby expressly incorporated by reference.

### STATEMENT OF GOVERNMENT LICENSE RIGHTS

The U.S. Government has a paid-up license in this invention and the right in limited circumstances to require the patent owner to license others on reasonable terms as provided for by the terms of 1 U01 DE14971-03 awarded by the National Institutes of Health.

### TECHNICAL FIELD

This invention generally relates to optical imaging and, more particularly, to a miniaturized optical imaging system suitable for Surface Plasmon Resonance imaging.

### BACKGROUND

In Surface Plasmon Resonance (SPR) imaging, an optical imaging system is used to observe biomolecular binding events that have spatial structure. Generally, such a system includes a light source to illuminate a sensor substrate under conditions which produce SPR and a detector to image the light reflected from the sensor substrate. As known in the SPR art, the sensor substrate is typically provided with a resonance layer of metal, such as gold (e.g., 50 nm thick layer). The side of the gold layer opposite from the sensor substrate faces an aqueous sample (including biomolecules), which is typically contained in a flow cell (a detector sensor volume). Light is directed through the sensor substrate and the gold layer to the aqueous sample, and is reflected therefrom. The amount of light reflection varies depending on the change in the refractive index (RI) of the sensor substrate upon adsorption of target biomolecules to the sensor substrate.

Specifically, for certain wavelengths and angles of incident illumination, part of the incident energy couples into a surface plasma wave traveling between the gold layer and the aqueous sample. The loss of this energy is observed as a decrease in reflectivity. Because the coupling conditions vary widely with the refractive index of biomolecules, observations of reflectivity may be used as a sensitive measure of the sample's refractive index, and hence of the biomolecules contained in the sample. Therefore, SPR reflectivity measurements can be used to detect various target biomolecules, such as proteins. To make an SPR imaging system for detection of specific biomolecules, the side of the gold layer, with which the sample interfaces, may be chemically functionalized (for instance, by attaching antibodies to the surface), such that the target biomolecules will bind to the sensor substrate while other material will tend not to bind. If the functionalized layer on the gold layer is patterned such that different regions tend to bind different biomolecules, the changes in reflectivity may be analyzed to determine which of a number of different biomolecules are present in the (aqueous) sample, and in what concentration. In other words, in SPR imaging, any spatial variation in surface RI across the sensor substrate causes the reflected intensity to have spatial structure. SPR imaging can be used, for instance, in medical diagnostics, to analyze a fluid (such as blood or saliva) and determine the concentration of a certain set of biomolecules in that fluid.

FIG. 1A illustrates a schematic diagram of an SPR imaging system 40 as disclosed in United States Patent Application Publication No. US2005/0134860 A1, published Jun. 23, 2005, which is hereby expressly incorporated by reference. The system 40 includes a light source 42, at least one input optical element 44, a sensor substrate 50, at least one output optical element 52, and a detector 60. The at least one input optical element 44 is illustrated as a collimating lens, which is disposed between the light source 42 and the sensor substrate 50. Preferably, the light source 42 is positioned at the focus of the collimating lens 44. The at least one output optical element 52 is illustrated as a lens, which is disposed between the sensor substrate 50 and the detector 60. Preferably, the lens 52 is capable of accepting light from the sensor substrate 50 at a range of angles corresponding to the range of angles at which light is emitted from the collimating lens 44. The sensor substrate 50 may be provided by a surface of a prism 48. Optionally, the SPR imaging system 40 further includes one or more wavelength/polarization-selection filters 46 between the at least one input optical element 44 and the sensor substrate 50. As discussed above, one side of the sensor substrate 50 that faces the sample (i.e., the top side in FIG. 1A) is provided (e.g., coated) with a resonance layer such as a gold layer.

FIG. 1B is a gray-scale plot that shows the transverse magnetic (TM) reflectivity of the SPR sensor substrate at various wavelengths, angles, and refractive indices. For a given refractive index (e.g., n=1.33), the plot shows the darkest region in the form of a curve descending from approximately 600 nm at 76 degrees to 1000 nm at 64 degrees. When the refractive index increases to 1.36, for example, the dark region (or the resonance position) moves higher in angle and wavelength. In SPR imaging, both the angle and wavelength are fixed (i.e., a single x-y point is being examined in FIG. 1B), and brightness changes are observed due to the changing refractive index. Thus, to sense refractive indices around 1.33, the wavelength and angle are set to some point on the dark curve for n=1.33.

Referring back to FIG. 1A, light emitted from the light source 42 passes through the collimating lens 44, passes through one side of the prism 48, and strikes the gold-layered sensor substrate 50 at an incident angle appropriate for observation of SPR. The reflected light passes through the lens 52 and is focused onto the detector 60, which records the image. It is proposed that the light source 42 may comprise a light-emitting diode (LED) array, and the angle of incidence may be varied by illuminating a selected one or more (e.g., a row) of the LEDs in the light source 42. FIG. 1A illustrates one ray 43 emitted from each of three different LEDs, each ray 43 striking the sensor substrate 50 with a different incident angle. Illuminating an entire row of LEDs as opposed to a single LED results in increased light throughput. Alternatively or additionally, to change the incident angle, it is proposed that the light source 42 may be configured to be linearly movable by a manual or motorized positioner off the optical axis of the imaging system 40, i.e., along the line representing the light source 42 in FIG. 1A. Thus, FIG. 1A may be viewed as illustrating the same light source 42 being positioned at three different locations to emit a ray from each of the locations. Further, the one or more filters 46 may be used for selecting the polarization and source wavelength range, for instance if a white light source is used. If LEDs are used, which emit a narrow range of wavelengths, further wavelength filtering may not be necessary though polarization filtering may be. Though the filter 46 is illustrated to be between the collimating lens 44 and the sensor substrate 50, it may be placed anywhere else in the optical path compatible with filter properties (such as the filter size and ability to accept light at non-normal incidence). The physical size and wavelength distribution of the light source 42 is adjusted such that the detector 60 operates just below saturation, so as to achieve the greatest signal-to-noise ratio (SNR).

Referring additionally to FIG. 1C, it is proposed that the detector 60 is positioned (or tilted) according to the Scheimpflug angle. Particularly, the sensor substrate 50, the output optical element (lens) 52, and the receiving surface of the detector 60 are positioned such that the planes of each (56, 57, and 58) intersect in a single line (or at a single point 59, as in FIG. 1C). Because the sensor substrate 50 is tilted relative to the illumination light, the image also should be tilted by an amount given by a relation termed the Scheimpflug condition, so as to achieve best focus. Superficially, the Scheimpflug condition states that if object (the sensor substrate 50) and image (the detector 60) are tilted such that the object plane (56), the image plane (58), and the lens plane (57) meet in a single line, then the entire image will be in sharp focus.

The present invention extends the SPR imaging system described above, to provide a miniaturized and highly-portable SPR imaging system having particular applicability to medical diagnostics and life sciences research and development.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with various exemplary embodiments of the present invention, a miniaturized Surface Plasmon Resonance (SPR) imaging system is provided, which includes a light source, a sensor substrate arranged to receive light at an incident angle from the light source, and a detector for detecting an image from the sensor substrate. The system further includes a folded light path structure arranged between the light source and the detector. The folded light path structure includes the sensor substrate, and is configured so as to receive the light from the light source, to redirect the received light to be incident on the sensor substrate at the incident angle (first redirection), and to further redirect the light reflected from the sensor substrate toward the detector (second redirection). The folded light path structure achieves a minimal instrumentation footprint, which in turn allows for the construction of a miniaturized, hand-portable SPR imaging system.

In accordance with one aspect of the invention, the miniaturized SPR imaging system further includes at least one input optical element between the light source and the folded light path structure, such as one or more of a collimation lens, wavelength-selection filter, and a polarizer. When a polarizer is included, the system may be advantageously configured to obtain a TE-polarized reference image for normalizing a TM-polarized image of the sensor substrate. The system may still further include at least one output optical element between the light path structure and the detector, which is capable of accepting light reflected from the sensor substrate. In one embodiment of the invention, the output optical element may include a pair of biconvex lenses and an achromatic lens. In accordance with a further aspect of the invention, wherein the output optical element comprises a lens, the light source, the detector, and the lens are arranged relative to each other so as to satisfy the Scheimpflug condition, thereby achieving sharp focus of the image of the sensor substrate.

In accordance with another aspect of the invention, the miniaturized SPR imaging system is further configured to be capable of adjusting focus and/or magnification of an image of the sensor substrate.

In accordance with a further aspect of the invention, the folded light path structure is configured such that the optical path resulting from the first redirection and the second redirection lies approximately in parallel with the sensor substrate. Also, the folded light path structure may include two symmetrical substructures on the light source side and the detector side, respectively. In one embodiment of the invention, such folded light path structure is formed with one main prism, one redirection optical element provided on each of the two sides of the main prism, and one deflection optical element also provided on each of the two sides of the main prism.

In accordance with yet another aspect of the invention, the folded light path structure includes one or more optical elements and the folded light path structure is further configured to adjust the one or more optical elements relative to the light source and the detector. For example, the one or more optical elements are adjustable at least linearly along one direction and angularly along the optical axis of the miniaturized SPR imaging system. Likewise, the light source and the detector may be adjustable at least linearly along one direction and angularly along the optical axis of the miniaturized SPR imaging system.

In accordance with a still further aspect of the invention, the incident angle of the light from the light source on the sensor substrate is adjustable. This could be accomplished, for example, by configuring the light source to selectively emit illumination light from two or more locations along a line perpendicular to the optical axis of the miniaturized SPR imaging system.

In accordance with further embodiments of the present invention, a miniaturized Surface Plasmon Resonance (SPR) imaging instrument is provided, including a miniaturized SPR imaging system described above. The SPR imaging instrument further includes a case that houses the miniaturized SPR imaging system, such that the sensor substrate is exposed to the outside of the case. The case also houses an electronic board for controlling the operation of the SPR imaging instrument. The SPR imaging instrument additionally includes a microfluidic card configured to be positioned adjacent to the exposed sensor substrate so as to subject an aqueous sample flowing therethrough to SPR imaging. Finally, the SPR imaging instrument includes a computer including a user interface to guide a user through the operation of the SPR imaging instrument. The computer is further loaded with suitable image processing and analysis software.

In accordance with one aspect of the invention, the microfluidic card comprises a window layer, a resonant (gold) layer formed on the window layer, and a flow layer formed on the resonant layer and including fluid paths for flowing the aqueous sample therethrough. The microfluidic card may be further configured to be mated with external fluidics that input and output the aqueous sample to be analyzed.

In accordance with another aspect of the invention, the miniaturized SPR imaging instrument further includes means for stabilizing the internal temperature of the case, such as a fan and/or a heater, to reduce and minimize wavelength drift or changes in a polarizer.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a schematic diagram illustrating an SPR imaging system;

FIG. 1B is a gray-scale plot illustrating reflectivity as dependent upon the wavelength of illumination, the angle of incidence of illumination, and the refractive index of the target sample;

FIG. 1C is a schematic diagram illustrating imaging of tilted surfaces pursuant to the Scheimpflug condition;

FIG. 2A is a schematic diagram illustrating a miniaturized SPR imaging system comprising a folded light path, in accordance with one embodiment of the present invention;

FIG. 2B is a schematic diagram illustrating the “unfolded” light path of the miniaturized SPR imaging system of FIG. 2A;

FIG. 3 is a diagram illustrating various components of a miniaturized SPR imaging system provided on (or in) adjustable mounts, formed in accordance with one embodiment of the present invention;

FIG. 4A is a perspective view of a complete SPR imaging instrument including a miniaturized SPR imaging system, external fluidics, and a microfluidic card, formed in accordance with one embodiment of the present invention;

FIG. 4B is a schematic, partial cross-sectional view of the external fluidics provided on the microfluidic card, which in turn is provided on the miniaturized SPR imaging system, as in FIG. 4A;

FIG. 5A is a sample SPR image obtained based on the use of a microfluidic card, in accordance with one embodiment of the present invention;

FIG. 5B is a chart illustrating the binding curves of different sections within the sample SPR image of FIG. 5A;

FIG. 6 is a sample user interface panel for guiding a user through the operation of an SPR imaging instrument;

FIG. 7 is another sample user interface panel for guiding a user through the operation of an SPR imaging instrument; and

FIG. 8 is a sample user interface screen for guiding a user through the operation of image processing analysis software, in accordance with one embodiment of the present invention.

### DETAILED DESCRIPTION

In accordance with various embodiments, the present invention offers a miniaturized optical system with a small instrumentation footprint, particularly designed to allow a highly sensitive SPR (SPR) bio-assay to be conducted over a sensor substrate that can contain many different simultaneous assays. The system utilizes an optimized imaging technique to resolve the assay response for very small localized regions anywhere in its field of view. The optical path through the system is designed to be very rugged and compact, with few or no moving parts. There are provisions to allow the response of the system to be tuned to optimize the sensitivity of the assay for a given protocol chemistry or for a particular set of samples.

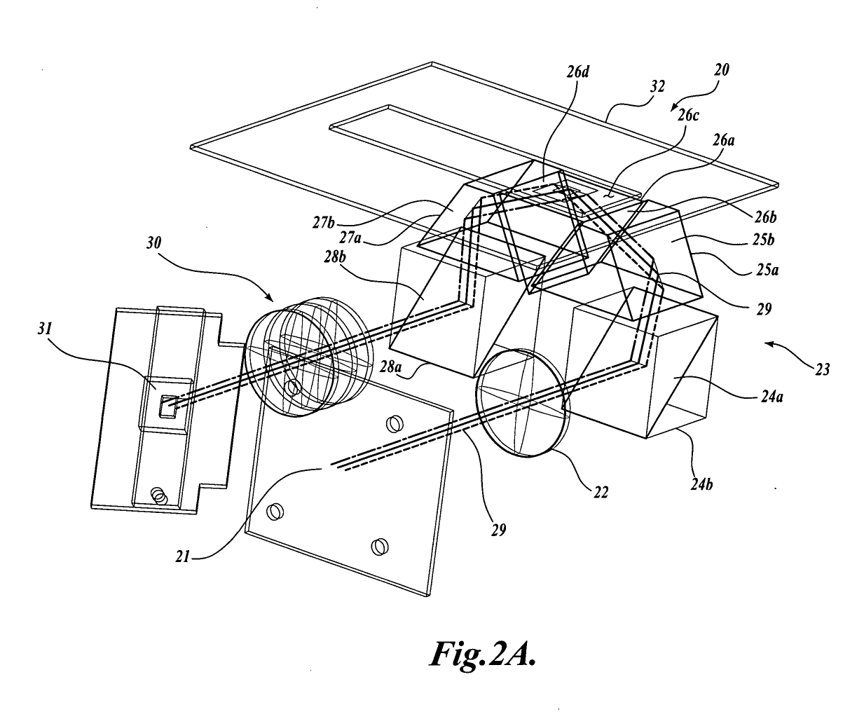

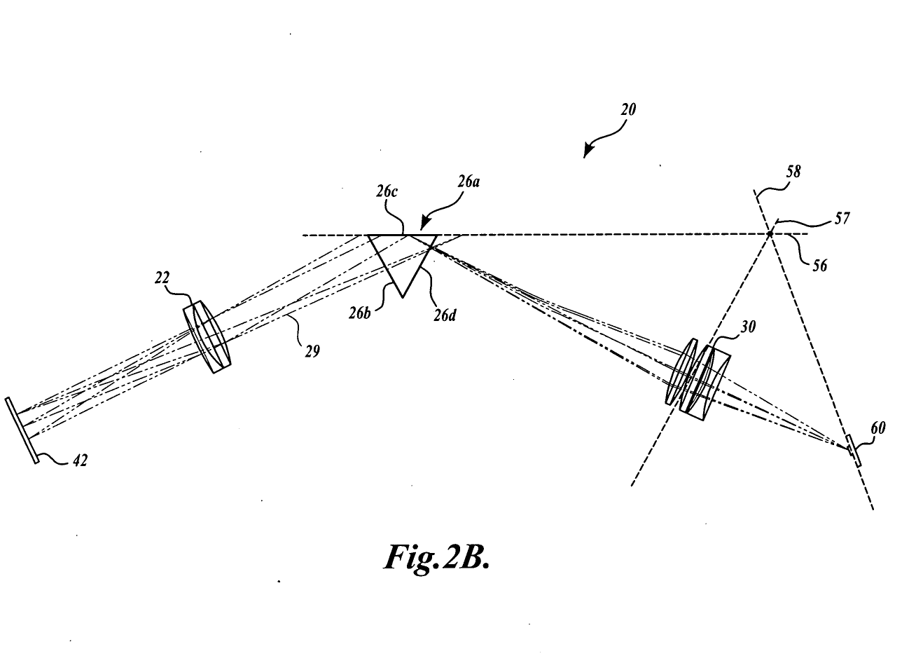

FIG. 2A illustrates a schematic diagram of a miniaturized SPR imaging system 20 in accordance with an embodiment of the present invention. The system 20 includes a light source (not shown) on a source mount 21, illumination optics 22 which may include, for example, wavelength/polarization-selection filters and collimating lens(es), and a folded light path structure 23. In the illustrated embodiment, the folded light path structure 23 includes a first 90°-deflection prism 24a, with its reflective (e.g., aluminum) hypotenuse plane sitting on a 90°-base prism 24b, a first redirection equilateral prism 25a, a main prism 26a, a second redirection equilateral prism 27a, and a second 90°-deflection prism 28a. The folded light path structure 23, as the name indicates, is configured to fold the light path so as to achieve a compact, miniaturized SPR imaging system with a minimal instrumental footprint.

In the illustrated embodiment, light rays (three are shown) 29 emitted from the light source propagate through the illumination optics 22 and strike the hypotenuse plane of the 90°-deflection prism 24a, from which the rays 29 are reflected to enter the first redirection equilateral prism 25a to strike its plane 25b, from which the rays 29 are reflected to enter the main prism 26a through one of its side planes 26b. The rays 29 then strike a sensor substrate 26c of the main prism 26a, and are totally internal-reflected therefrom to exit the main prism 26a through the other of its side planes 26d, to enter the second redirection equilateral prism 27a to strike its plane 27b. The rays 29 reflected from the plane 27b exit the second redirection equilateral prism 27a to enter the second 90°-deflection prism 28a to strike its hypotenuse plane 28b, from which the rays 29 are reflected to exit the second 90°-deflection prism 28a to enter imaging optics 30, such as lens(es), to be finally received by an image detector (not shown) on a detector mount 31. Thus, an image of the sensor substrate 26c is formed on the detector. Note that the sensor substrate 26c of (or on) the main prism is provided with a metal layer, such as gold, on the side that faces an aqueous sample to be analyzed (i.e., the top side in FIG. 2A). In one embodiment, the sensor substrate 26c is directly coated with a gold layer. In another embodiment, a glass window (e.g., microscope slide) 32 is provided and index-matched to the sensor substrate 26c, and the gold layer may be applied over the window 32.

As should be apparent to those skilled in the art, the folded light structure 23 illustrated in FIG. 2A is merely an example, and other structures including fewer or more number of optical elements to achieve the same or different folded light paths are also within the scope of the present invention.

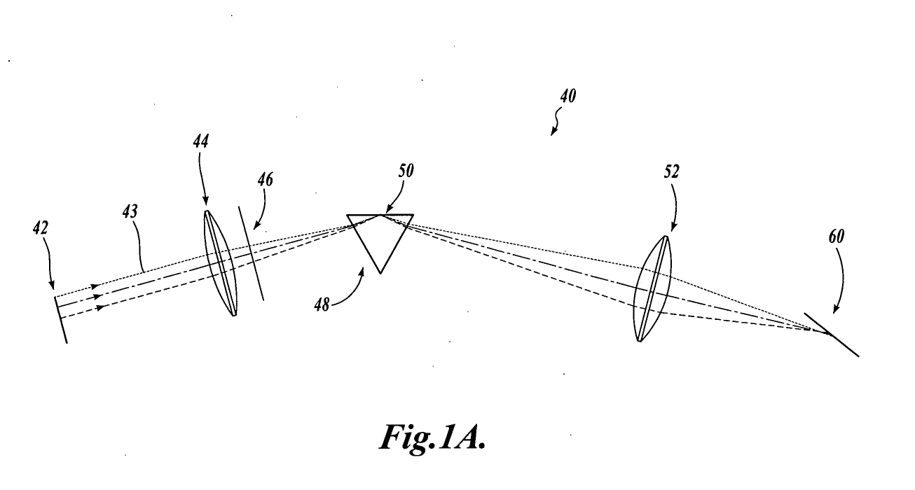

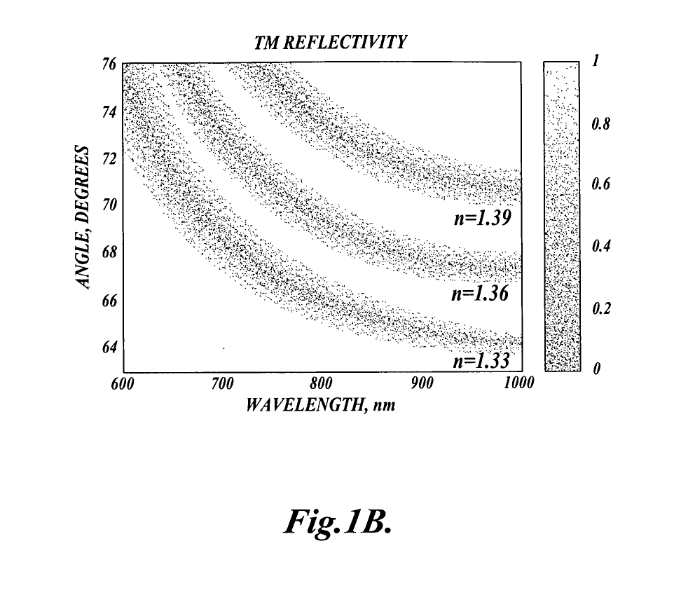

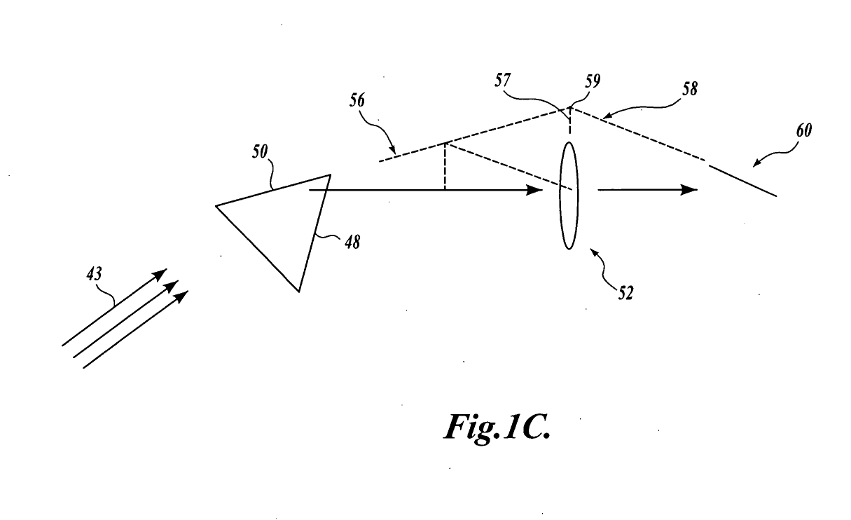

FIG. 2B illustrates the “unfolded” light path corresponding to the folded light path illustrated in FIG. 2A. Note that, unlike FIG. 2A, FIG. 2B does not show the first and second 90°-deflection prisms 24a and 28a nor the first and second redirection equilateral prisms 25a and 27a. FIG. 2B is similar to FIG. 1A, indicating that the miniaturized SPR imaging system 20 is a further extension of the SPR imaging system 40 shown in FIG. 1A, and as such many preferable features of the SPR imaging system 40 may be used in the miniaturized SPR imaging system 20 also.

In the illustrated embodiment of FIG. 2B, the light source 42 is preferably a collimated light source and may comprise one or more LEDs, for example, 880 nm surface-mount (SMT) LED array. As discussed in the background section above, by selectively activating one or a row of LEDs, the incident angle of illumination may be adjusted (three different incident angles are shown). The illumination optics 22 may comprise a lens 22 having the focal length F of 75 mm. The imaging optics 30 may comprise a series of lenses (three are shown), including two 50 mm Bi-Convex (BCX) lenses and a −75 mm achromatic lens. The detector 60 may be a 4.8 mm×3.6 mm CCD detector, and in the illustrated embodiment is tilted to satisfy the Scheimpflug condition to reduce focus errors. Specifically, as described in reference to FIG. 1C above, in FIG. 2B also, the image plane 58 of the detector 60 is tilted such that it intersects with both the object plane 56 and the lens plane 57 in a single line, to render the image in sharp focus.

The following describes in detail various subsystems of a miniaturized SPR imaging system formed in accordance with various exemplary embodiments of the present invention. Thereafter, implementation of a complete miniaturized SPR imaging instrument will be described.

Illumination Subsystem

As used herein, the illumination subsystem includes the light source 42, the illumination optics 22, and the folded light path structure 23. The signal produced by an SPR imaging system is highly dependent on the wave vector of the illumination. Therefore, preferably, the illumination subsystem illuminates the entire sensor substrate 26c with light that has a uniform wave vector and radiance. Achieving uniform radiance helps optimize the signal-to-noise ratio (SNR) in the imaging system. Also, a non-uniform wave vector could result in different portions of the sensor substrate 26c having different response calibration, yielding complicated nonlinear results. Different assay chemistries require different wave vectors of illumination for optimal response. Therefore, it is further preferable that the illumination subsystem allows the illumination wave vector to be adjusted to achieve optimized sensitivity.

One way to adjust the wave vector is to fix the spectral content of the illumination and then vary angle of the illumination on the sensor substrate 26c. In one embodiment of the present invention, this is achieved by using a light source 42 with a narrow spectral width and moving the light source 42 relative to the illumination (collimation) optics 22. The illumination (collimation) optics 22 are chosen to produce a beam with a uniform wave vector for a range of light source positions relative to the optical axis of the imaging system. When the light source 42 is translated relative to the optical axis, as shown in FIG. 2B, the output beam will point in a different direction. Therefore, the output beam will still have a uniform wave vector across its width, but the wave vector relative to the optical axis will vary. The translation of the light source 42 may be accomplished by linearly moving the point or line light source 42, or by selectively activating a point or line light source in an array of light sources, as discussed above. This variable angle effect can also be achieved using other techniques such as, without limitation, directing collimated light into an acoustic modulator, a rotating prism, or a rotating mirror.

Another way to adjust the wave vector is to fix the angular content of the beam and vary the wavelength content. In one embodiment of the present invention, this is achieved by putting a broad wavelength source through an interference filter to narrow the spectral width of the output. Such interference filter may be provided as part of the illumination optics 22. If the filter is tipped, the central wavelength of the output beam can be varied over a range of wavelengths. In this fashion, the output beam will still have a uniform wave vector across its width, but the wave vector will vary with wavelength. This spectral adjustment can also be accomplished using techniques such as, without limitation, rotating prisms or diffractions gratings, but these may not produce a very uniform wave vector across the beam. Using a technique such as, without limitation, a fiber optic to mix the output prior to collimation will help solve this issue.

The light source 42 may comprise, without limitation, one or more LEDs with narrow spectral width at 660 nm, 880 nm, or 920 nm; one or more LEDs with a broad spectral width, an incandescent source, a fluorescent source, a laser source, an optical fiber, among others, either alone as a single point source, as a line source (such as a row of LEDs or a rectangular fiber bundle, thereby improving flux with increased light throughput without significantly increasing the range of wave vectors in the illumination beam), or as a two-dimensional array.

The techniques for adjusting the light source 42 may include, without limitation, a single light source provided on a moving mount that is driven by a manual or motorized actuator, an array of light sources where each source can be individually controlled such that only the source(s) that produces the optimal wave vector is turned on, and a wavelength-selection filter (e.g., as part of the illumination optics 22) on a moving mount driven by an actuator, which causes the filter to tip relative to the optical axis.

Polarization Control

The signal produced by an SPR imaging system is highly dependent on the polarization state of the illumination beam. When the beam is TE (Transverse Electric) polarized relative to the sensor substrate 26c, no SPR occurs and the image recorded by the detector 60 will represent the illumination transfer function of the entire imaging system. When the illumination beam is TM (Transverse Magnetic) polarized, an SPR imaging signal can be recorded by the detector 60. However, this signal will also contain all the non-uniformities caused by the rest of the system throughput. In accordance with various exemplary embodiments of the present invention, the TE reference image is used as a “real time” reference to normalize the TM image so as to remove the non-uniformities, leaving only the SPR image signal from the sensor substrate 26c. In one embodiment of the present invention, a liquid crystal element (as part of the illumination optics 22) is used to rotate the polarization state of the incident illumination by applying a voltage to the liquid crystal element. Other techniques for varying the polarization state include, without limitation, an actuator-driven stage to rotate a piece of linear polarizer.

Folded Light Path

In various exemplary embodiments of the present invention, the optical paths of the illumination and SPR imaging signal light are folded up in an approximately symmetrical fashion using identical components, as described in reference to FIG. 2A above. Other embodiments, where the optical paths are not necessarily symmetrical, are also within the scope of the present invention, depending on the specific application. One purpose of folding the light path is to produce a portable SPR imaging system with a minimized footprint. To that end, in various exemplary embodiments of the present invention, the light path is folded such that the optical axis lies along a plane (or planes) that is approximately parallel with the sensor substrate 26c. See, for example, the embodiment of FIG. 2A, where the optical axis from the light source mount 21 to the detector mount 31 is approximately parallel with the sensor substrate 26c.

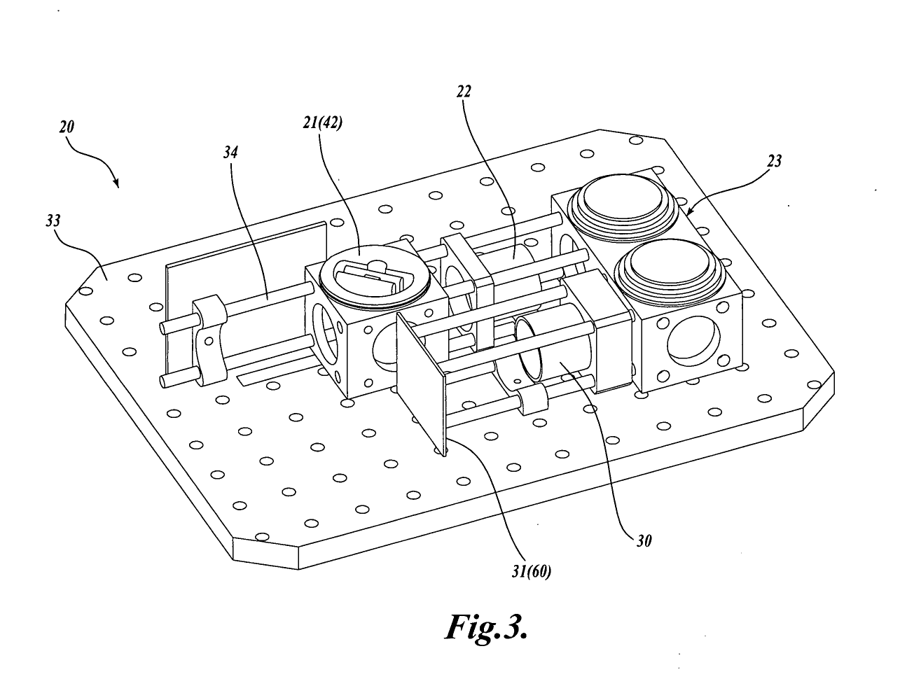

In this embodiment, the illumination beam is first folded by the first 90°-deflection prism 24a with its mirrored hypotenuse plane, to be perpendicular to the sensor substrate 26c. While the prism 24a is used in this embodiment to simplify the mounting and cleaning of optics, the 90°-deflection may also be achieved with a mirror. Whatever deflection optic is used, it may be mounted on (or in) an adjustable mount that allows three axes of angular adjustment and one axis of linear adjustment. For example, referring additionally to FIG. 3, the miniaturized SPR imaging system 20 of FIGS. 2A and 2B may be mounted on a board 33, with various components such as the deflection optics (not shown) in a linearly adjustable manner along the direction of a linear adjustor element 34. Likewise, mounts for various components may be configured to be angularly adjustable so as to allow three axes of angular adjustment to the components, such as the deflection optics. These adjustments can be used to optimize the position of the illumination beam onto the sensor substrate 26c. Note that, in FIG. 3, the sensor substrate 26c of the miniaturized SPR imaging system 20 is facing downward, and in that sense FIG. 3 is an upside-down view of FIGS. 2A and 2B.

After the deflection optic, the beam is redirected from the normal (i.e., perpendicular to the sensor substrate 26c) to the sensor substrate 26c so that it illuminates the backside of the sensor substrate 26c at a grazing angle. In the embodiment illustrated in FIG. 2A, this redirection is accomplished using a redirection prism 25a, but may also be achieved with the use of a mirror. In the illustrated embodiment, the geometry of the redirection prism 25a is chosen so that the nominal optical axis of the redirected beam intersects the sensor substrate 26c at 75° from normal. It should be appreciated by those skilled in the art that the incident angle may be at any nominal value and may be adjusted over any range.

One advantage of using a redirection prism 25a is that it can be bonded to the main prism 26a. This provides a simple way to construct the miniaturized SPR imaging system 20. In other embodiments, the main prism 26a may be constructed with a monolithic shape that has the characteristics of a redirection prism bonded to a main prism.

In the embodiment illustrated in FIG. 2A, a second redirection prism 27a is provided such that the SPR imaging signal light reflected from the sensor substrate 26c is redirected to be normal to the sensor substrate 26c. This redirection prism 27a may be bonded to the main prism 26a or formed directly as part of a monolithic shape. After exiting the second redirection prism 27a, the SPR imaging signal light is deflected to be generally parallel to the sensor substrate 26c. For the deflection, a second 90°-deflection prism 28a or a mirror may be used, which may further be mounted on (or in) an adjustable mount similar to the first 90°-deflection prism 24a on the illumination side.

Mounting the Main Prism and Sensor Substrate

In one embodiment of the present invention, the main prism 26a is bonded to one side of a large, flat glass window 32, the other side of which is coated with gold. The sensor substrate 26c is index-matched to the window 32 so that the center of the sensor substrate 26c intersects the optical nominal axis of the illumination beam. The use of the window 32 is advantageous in that it provides a simple way of holding the main prism 26a in proper position. Further, the window 32 is easy to mount to the rest of the SPR imaging system 20, and also serves as a flat support surface to ensure that the sensing surface (as provided by the gold layer) remains flat. Finally, the window 32 helps protect the rest of the SPR imaging system 20 by minimizing any sample leaks and also containing excessive amounts of index matching.

Imaging Optics and Detector

The imaging optics 30 are responsible for creating a crisp image of the sensor substrate 26c on the detector 60. Because the sensor substrate 26c is tipped relative to the optical axis of the illumination side, the detector 60 also should be tipped in a configuration known as the Scheimpflug condition to achieve best focus, as discussed above. In accordance with various exemplary embodiments of the present invention, it may be further preferable to magnify the image by a factor of 1.5, a condition that makes the SPR imaging system more linear than can be achieved by simply obeying the Scheimpflug condition. It is still further preferable that the image remains stable on the detector 60 even when the angle of the illumination beam is adjusted.

To achieve one or more of these preferable features, in one embodiment of the present invention as illustrated in FIG. 2B, an objective lens (part of the imaging optics 30) is split into a pair of biconvex lenses to minimize aberrations and utilize commonly available lenses. This lens pair is followed by a negative lens (e.g., −75 mm achromatic lens) to act as a field flattener. The use of an achromatic element is preferable to further reduce aberrations. It should be understood by those skilled in the art that other lens combinations can also be used to accomplish the same goals, including but not limited to placing a field flattener in near proximity of the detector 60 to further correct field curvature and letting the field flattener be off center relative to the optical axis to better correct the non-linearity caused by the off axis imaging.

In one embodiment of the present invention, the detector 60 is a rectangular (e.g., 4.8 mm×3.6 mm) CCD array detector placed at the image plane 58 of the SPR imaging system. In various exemplary embodiments of the present invention, the detector 60 is mounted in such a way that it can be translated in three axes and rotated in two axes in order to achieve optimal focus. Preferably, the detector 60 is at least rotatable around the optical axis in order to account for any tip and tilt imparted by the mounts of the deflection prisms (e.g., the first and second 90°-deflection prisms 24a and 28a). At the same time, the illumination subsystem (comprising the light source 42, the illumination optics 22, and the folded light path structure 23) is preferably rotatable around its optical axis to keep everything aligned.

Stable Thermal Environment

To achieve a stable SPR imaging signal, it is preferable that the thermal environment for the optical path either remains constant or is corrected for by the software. Software correction typically works only over a relatively small temperature range, so a sound thermal design is preferable for a system to be stable over a relatively large temperature range. Temperature variation can cause the wave front to wander due to: mechanical variation in the mounting structure, wavelength drift of the light source 42, wavelength drift of any optical filters (if used as the light source 42), and/or changes to the polarizer.

In one embodiment of the present invention, the temperature is stabilized slightly above ambient temperature using a fan to circulate the air inside a case (containing the optics) and a heater on a controller to add just enough heat. Another embodiment uses a circulating fan and a heat pipe to pull the heat from the imaging electronics out of the case. An external fan on a controller may also be used to control the amount of heat conducted out of the case. Those skilled in the art will appreciate that various other techniques to stabilize the internal temperature of the system are also within the scope of the present invention.

Hyperspectral Imaging

The embodiments discussed so far are intended to monitor an illumination beam with a stable wave vector over a period of time to establish an assay for a given location. This is a single point measurement scheme, and even with careful normalization against a “real time” reference image (e.g., the TE reference image) and careful stabilization of the system, it is prone to undesirable wavelength drift. This drift can be minimized or eliminated by moving from a single point measurement to a multipoint measurement. One way to accomplish this is to measure a range of wave vectors at each location in rapid succession. It is then possible to recover a more stable signal using signal processing techniques such as, without limitation, ratiometric techniques, minima hunting, correlation techniques, or regression techniques.

One technique of achieving such data from a range of wave vectors is to time share the detector 60. If the illumination beam is fixed at an angle and a series of successive images are taken at different wavelengths, the spectra for each pixel on the detector 60 can be built up from the same corresponding pixel in the series of images. This is a technique referred to as hyperspectral imaging. A similar set of hyperspectral data can also be taken with a fixed wavelength and a rapid series of images at different illumination angles. In various exemplary embodiments of the present invention, the use of hyperspectral image processing improves the functionality of the SPR imaging system.

Implementation of the Complete Instrument

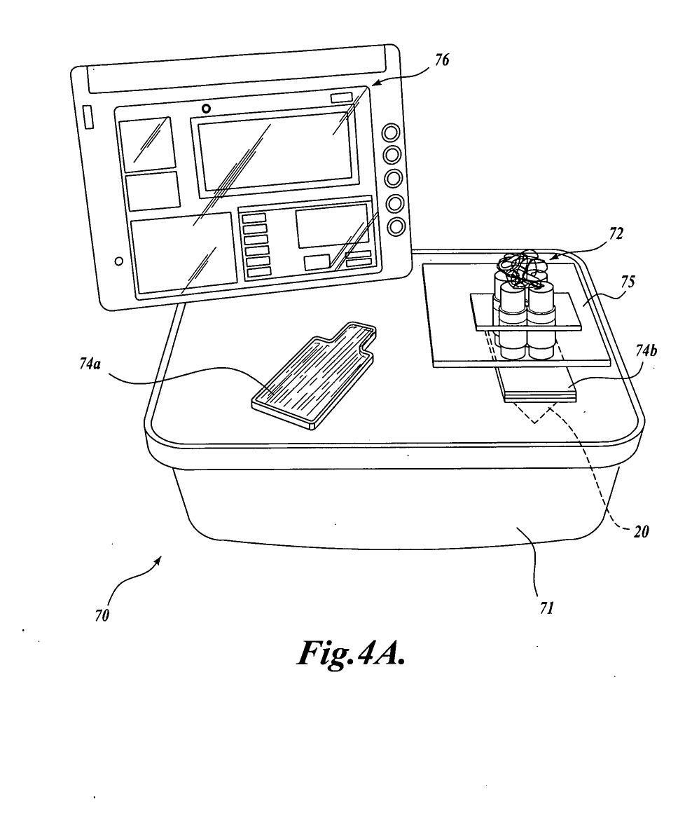

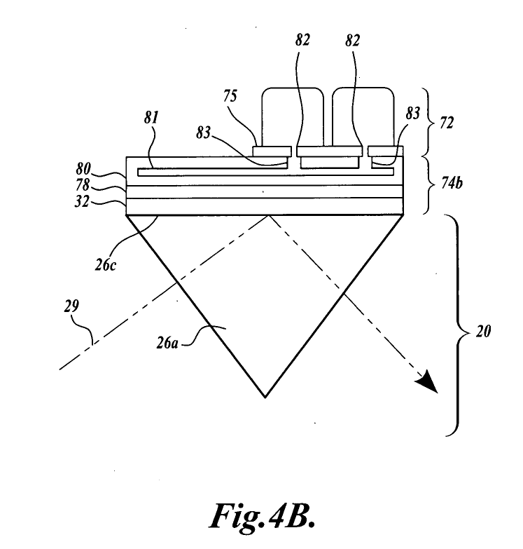

The miniaturized SPR imaging system with a small footprint, as described above, may be readily incorporated into a complete SPR imaging instrument 70, as shown in FIG. 4A. The SPR imaging instrument 70 generally includes a case 71, which houses a miniaturized SPR imaging system 20 (not clearly shown in FIG. 4A). The instrument 70 further includes external fluidics 72 comprising a silicone manifold for inputting and outputting aqueous sample(s) to be analyzed, and a microfluidic card 74a, 74b that is configured to mate with both the miniaturized SPR imaging system 20 and the external fluidics 72. Briefly, the card 74a, 74b is configured to flow aqueous sample(s), supplied from the external fluidics 72, within the card along the paths in parallel with the plane of the card, such that the aqueous samples will flow adjacent to the sensor substrate 26c of the miniaturized SPR imaging system 20 to produce an SPR image signal. In the illustrated embodiment, the card 74a is provided as a spare, while the card 74b is positioned to mate with both the miniaturized SPR imaging system 20 (housed within the case 71, underneath the card 74a in FIG. 4A, with its sensor surface 26c facing upward) and the external fluidics 72 including a (plastic) plate 75 (placed on top of the card 74a in FIG. 4A). Further, the SPR instrument 70 includes a computer 76 with a user-interface for user control/operation of the SPR instrument 70, such as a table PC. Finally, the SPR instrument 70 includes, within the case 70, a digital-signal-processor (DSP) for controlling image acquisition and transfer, and an electronic board for control of light source(s) 42 and the valves and pumps of the external fluidics 72. The case 71 provides light shielding so that the SPR instrument 70 may be used in normal room lighting. As one can appreciate, the SPR instrument 70 may be constructed in a compact, hand-portable form, in accordance with various exemplary embodiments of the present invention.

(a) Microfluidic Card

Referring additionally to FIG. 4B, a microfluidic card 74b may include a window layer 32 (provided by a microscope slide, for example), a gold layer 78 formed thereon, and a flow layer 80 including fluidic paths 81 running therethrough. In one embodiment, the flow layer 80 contains a flow cell fabricated from multiple layers of laser-cut Mylar and adhesive. (Note that FIG. 4B is a schematic diagram for illustrating the relative positioning of various elements, and thus the elements are not to scale.) When mated with the miniaturized SPR imaging system 20, the fluidic paths 81 within the flow layer 80 run generally in parallel with the sensor substrate 26c of the main prism 26a. Further, when mated with the external fluidics 72, tubes 82 running through the plate 75 of the external fluidics 72 may be inserted into fluidic ports 83 in the flow layer 32 of the card 74b, to thereby input and output aqueous samples into and out from the fluidic paths 81. In one embodiment of the present invention, a magnetic clamping mechanism may be provided for reproducible placement of the microfluidic card 74b on the SPR instrument 70. Prior to such placement, preferably, the window layer 32 is index-matched to the sensor substrate plane 26c of the main prism, for example, by dropping index matching liquid therebetween. In a further embodiment of the present invention, the microfluidic card 74 is configured to be disposable after a single use.

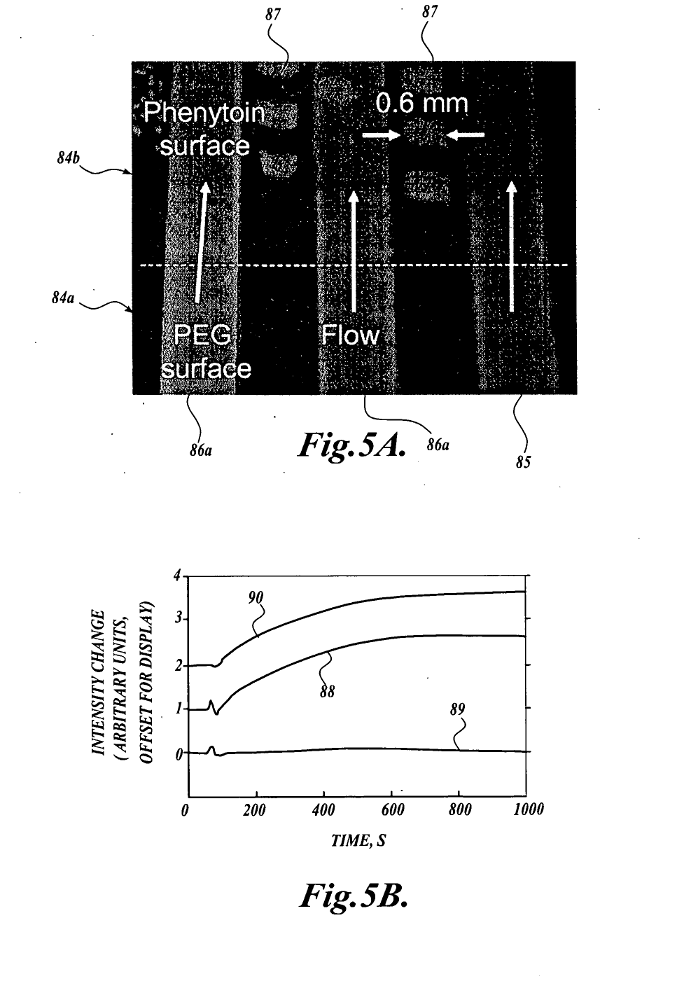

FIG. 5A illustrates, as an example of how the microfluidic card 74b may be used in SPR imaging, an SPR image of an immunoassay detection region composed of a nonfouling (i.e., cell or protein resistant) coating sub-region, such as a polyethylene glycol (PEG) surface 84a, upstream of the gold-layered sensor substrate sub-region that is functionalized for phenytoin-bovine serum albumin, such as a phenytoin surface 84b. The image shows a sample channel 85, and two reference channels 86a and 86b that are used for the quantification of positive control samples and serve as on-card calibrators. The bright rectangles 87 between the channels 85, 86a, and 86b are regions of adhesive on the gold layer 78, which may be used to produce reference signals for the purpose of monitoring light intensity fluctuations. FIG. 5B shows the signal as a function of time due to the binding of phenytoin antibody in buffer, for example a binding curve 88 of phenytoin antibody in buffer (i.e., the target) to the phenytoin-bovine serum albumin functionalized gold layer under stopped flow conditions. The binding curve 89 for the nonfouling PEG surface 84a shows no detectable adsorption, as expected. The difference signal is shown as a curve 90. Note that in the difference curve 90, the wiggles at the start of the other two curves have been subtracted out. The offset of the three curves is arbitrary and for display purpose only.

(b) DSP Software

In one embodiment of the present application, a Texas Instruments TMS320C6410 DSP may be used to control the CCD image detector 60 that captures the reflected light and to transfer the resultant SPR images to the computer 76 (e.g., the tablet PC) for processing and analysis. The specific functions of the DSP software, which was developed in the Texas Instruments Code Composer Studio software development environment, include setting the image detector shutter speed, acquisition of images from the detector, averaging the images to remove temporal noise, and transmission of the averaged images via Ethernet to the tablet PC.

(c) Tablet PC Software

The computer (e.g., tablet PC) software is responsible for control of the SPR imaging instrumentation, processing and analysis of the averaged SPR images, and for providing a simple user interface to guide a user through the experimental procedure. In one embodiment, the instrumentation control and user interface software were developed in the National Instruments LabWindows/CVI software development environment, while the SPR image processing and analysis software was developed in the Mathworks Matlab environment.

In one embodiment of the present invention, the image acquisition software module connects to the DSP via two Ethernet channels. The first channel is used to launch the program on the DSP. The second channel is used for transmitting images from the DSP and sending to the DSP the desired image detector shutter speed and number of images for averaging. Each image received from the DSP may be stamped with the time it was received from the DSP, the number of images averaged, and the shutter speed, before being saved to disk for processing and analysis. In addition, the most recently acquired image may be displayed on the computer 76 screen at a reduced resolution.

The flow of fluids through the SPR imaging instrument 70 may be controlled by a set of six Kloehn syringe pumps, which is part of the external fluidics 72. In one embodiment, each pump, which contains a 6-way valve, syringe, and stepper motor, is individually programmed via an RS-232 serial connection. The software sets the valve position and determines the distance and velocity for syringe activity in units of motor steps based on the syringe volume, fluid flow duration, fluid flow direction (aspirate or dispense), and fluid volume.

The intensity of the light source 42, such as an LED light source, may be set via a codeword corresponding to the current to be sent to the LEDs. The codeword is transferred to the electronic control board via a serial connection using the RS-232 protocol.

The rotation angle for the electronic polarizer (as part of the illumination optics 22) may be set via a codeword transferred to the electronic control board via an RS-232 serial connection. In one embodiment, a codeword of zero corresponds to TM polarization and a codeword of 1974 corresponds to TE polarization.

In one embodiment, a set of four valves (part of the external fluidics 72) controls the flow path of fluids in the microfluidic card 74b. The software sets each valve to either an open or closed state using a binary code, which is transferred to the electronic control board via an RS-232 serial connection. In one embodiment, three of the valves operate in unison, thus requiring a two-bit code.

(d) User Interface

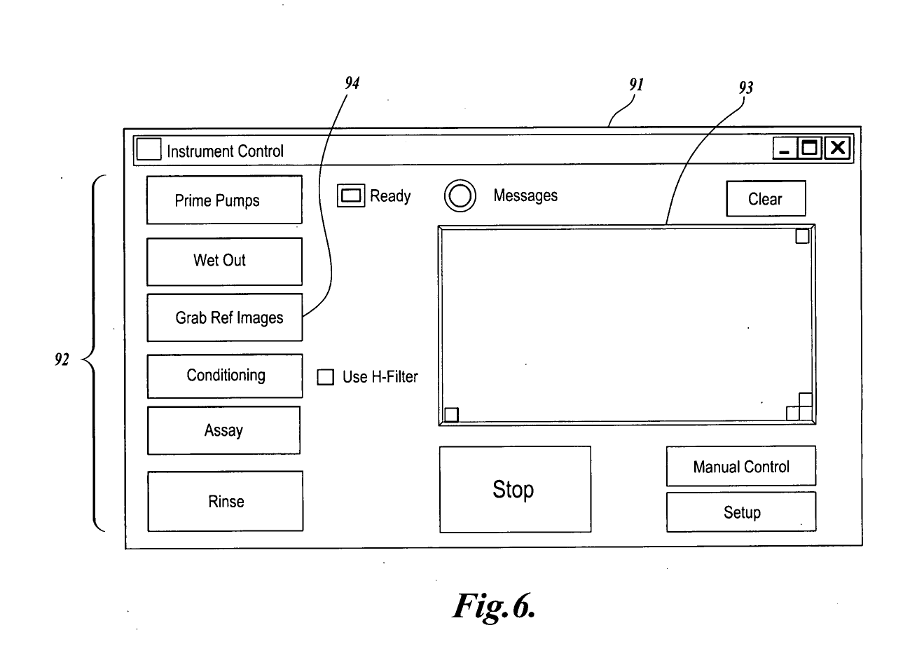

In accordance with various exemplary embodiments of the present invention, the SPR imaging instrument 70 offers a graphical user interface consisting of multiple panels, to guide users through the experimental procedure. The main panel 91 of the user interface, which is shown in FIG. 6, consists of a set of buttons 92 and a message box 93. The message box 93 informs the user when to perform each task in the experimental procedure.

In the illustrated embodiment, five of the buttons 92 correspond to a fixed set of pump and valve operations, thereby eliminating the need for the user to be aware of fluid flow rates and volumes. The sixth button 94 adjusts the polarizer and light source for the acquisition of dark, TE-polarization, and TM-polarization reference images. Finally, a “STOP” button is available to immediately terminate all pump activity.

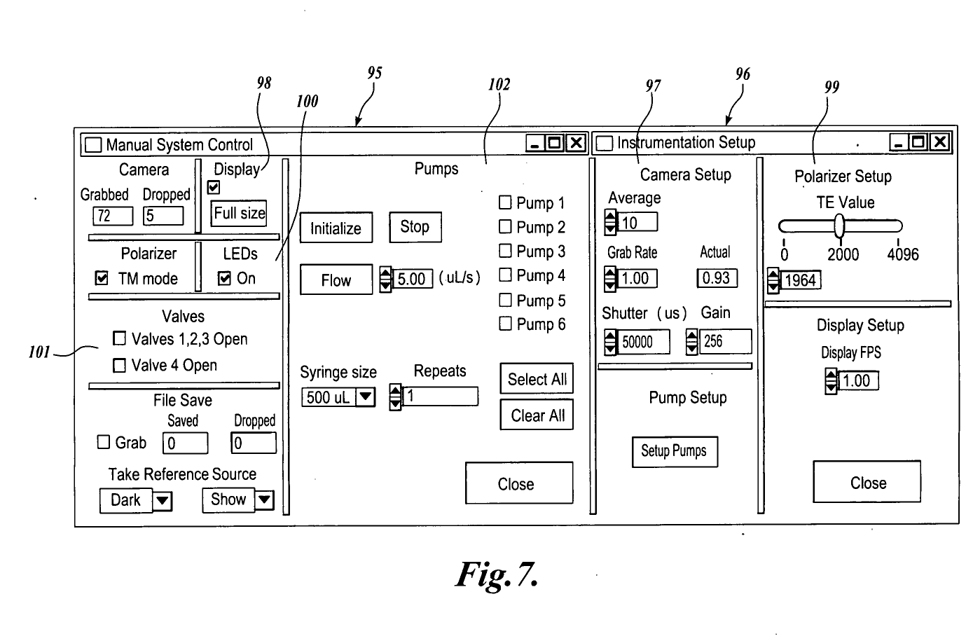

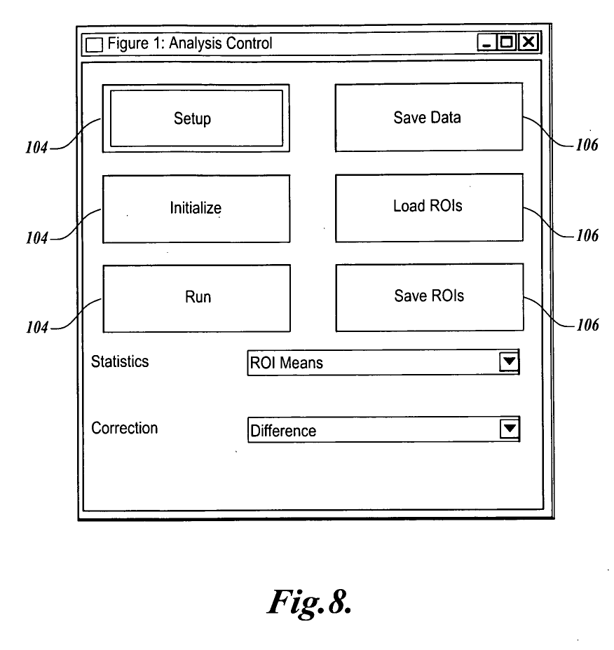

For advanced control of the SPR imaging instrument 70, as shown in FIG. 7, two additional interface panels (“Manual System Control” panel 95 and “Instrumentation Setup” panel 96) may be provided. These panels may be used to allow manual control of the “Camera Setup” 97, such as grab rate, shutter speed, and image averaging, the “Display” 98, such as display rate and full-resolution view of an image, the “Polarizer Setup” 99, such as TE/TM polarization, the light source or “LEDs” 100 (on/off), the “Valves” 101 (open/closed), and the “Pumps” 102, such as syringe size, flow rate, flow direction and flow duration.

(e) Image Processing and Analysis

As discussed above, one embodiment of the image processing and analysis software was implemented in Mathworks Matlab, to provide on-the-fly experiment results for the user. The user interface for the image processing and analysis software is shown in FIG. 8. The three buttons 104 on the left side correspond to the three main modules: an initialization procedure (“Initialize”), an on-the-fly analysis routine (“Run”), and a setup panel for advanced control of the initialization and analysis routines (“Setup”). The other three buttons 106 allow the user to save data and load or save the region of interest (ROI) locations.

The initialization procedure automatically finds the directory containing the current set of SPR images, initializes the regions of interest (e.g., rectangular areas used for data analysis) in the images, loads the dark, TE and TM reference images, and sets up the graphs for the data display.

In one embodiment, the analysis routine, which checks for images periodically based on a timer, gives the user a choice of four ways to visualize data. The first method is a plot of the mean spatial intensity of each region of interest over time. The user also has the option of specifying whether the images are corrected for background, dark, and illumination noise. Second, the images can be subtracted from a reference image to show differences in intensity from a known point in time. Two other ways to visualize the data are via horizontal and vertical line profiles. Third, specifically, a single row or column of each image is displayed as a line plot depicting intensity as a function of spatial location. The same line from each progressive image is appended to the display using a different color to allow temporal analysis of the line. Alternatively, multiple rows or columns can be averaged together for the line profiles. The fourth data visualization method is a histogram of pixel intensities that is destructively updated for each image.

As described hereinabove, the present invention, in accordance with various exemplary embodiments, offers a miniaturized SPR imaging system with a minimal footprint, which in turn makes possible a compact and portable SPR instrument containing such miniaturized SPR imaging system. In addition to being compact, the miniaturized SPR imaging system of the present invention includes a robust optical path that may be adjustable (in terms of focus, magnification, illumination wavelength, illumination incident angle, etc.) so as to achieve optimal illumination onto the sensor substrate and optimal imaging onto the detector. The miniaturized SPR imaging system is also designed to be mechanically robust in order to hold its adjustment. Further features may be provided to allow the image to be stable for a range of conditions of the light source illumination, including changes in the wavelength, angle of incidence, and polarization.

The SPR instrument in accordance with the present invention enables rapid, convenient desktop monitoring of biochemical binding interactions, for instance for immunoassays. The miniaturized SPR imaging system described herein is useful for many applications, including those requiring (1) detection and/or quantification of biological binding events; (2) detection and/or quantification of other binding or adsorption processes; or (3) refractometry of substances or surfaces which have a spatial distribution. Thus, it has particular applicability to medical diagnostics and life sciences research and development. While this invention is generally directed to a miniaturized high-performance SPR imaging system, it will be appreciated by those skilled in the art that the optical imaging system disclosed herein could be useful for many applications. Other angle-dependent optical sensing techniques such as ellipsometry and Brewster angle microscopy will likewise benefit, as will imaging or illumination systems in which facile adjustment of illumination conditions is needed.

While illustrative embodiments have been illustrated and described, it will be appreciated that various changes can be made therein without departing from the spirit and scope of the invention.

The embodiments of the invention in which an exclusive property or privilege is claimed are defined as follows:

1. A miniaturized Surface Plasmon Resonance (SPR) imaging system, comprising:
a light source;
a sensor substrate arranged to receive light at an incident angle from the light source;
a detector for detecting an image from the sensor substrate; and
a folded light path structure arranged between the light source and the detector and including the sensor substrate, the folded light path structure being configured so as to receive the light from the light source, to redirect the received light to be incident on the sensor substrate at the incident angle (first redirection), and to further redirect the light reflected from the sensor substrate toward the detector (second redirection).

2. The miniaturized SPR imaging system of claim 1, further comprising a resonance metallic layer disposed on the sensor substrate.

3. The miniaturized SPR imaging system of claim 1, further comprising:
at least one input optical element between the light source and the folded light path structure, which is capable of accepting light from the light source; and
at least one output optical element between the light path structure and the detector, which is capable of accepting light reflected from the sensor substrate.

4. The miniaturized SPR imaging system of claim 3, wherein the at least one input optical element comprises an element selected from a group consisting of a collimating lens, a wavelength-selection filter, and a polarizer.

5. The miniaturized SPR imaging system of claim 3, wherein the at least one input optical element comprises a polarizer, and the system is further configured to obtain a TE-polarized reference image for normalizing a TM-polarized image of the sensor substrate.

6. The miniaturized SPR imaging system of claim 3, wherein the at least one output optical element comprises a pair of biconvex lenses and an achromatic lens.

7. The miniaturized SPR imaging system of claim 3, wherein the at least one output optical element comprises a lens, and the light source, the detector, and the lens are arranged relative to each other so as to satisfy the Scheimpflug condition.

8. The miniaturized SPR imaging system of claim 3, which is further configured to be capable of adjusting the focus and/or magnification of an image of the sensor substrate.

9. The miniaturized SPR imaging system of claim 1, wherein the folded light path structure is configured such that the optical path resulting from the first redirection and the second redirection lies approximately in parallel with the sensor substrate.

10. The miniaturized SPR imaging system of claim 1, wherein the folded light path structure comprises at least one deflection optical element, at least one redirection optical element, and a main prism that provides the sensor substrate.

11. The miniaturized SPR imaging system of claim 10, wherein the at least one deflection optical element comprises a 90°-deflection prism, and the at least one redirection optical element comprises an equilateral prism.

12. The miniaturized SPR imaging system of claim 1, wherein the folded light path structure comprises two symmetrical substructures on the light source side and the detector side, respectively.

13. The miniaturized SPR imaging system of claim 1, wherein the folded light path structure comprises one or more optical elements and the folded light path structure is further configured to adjust the one or more optical elements relative to the light source and the detector.

14. The miniaturized SPR imaging system of claim 13, wherein the one or more optical elements are adjustable at least linearly along one direction and angularly along the optical axis of the miniaturized SPR imaging system.

15. The miniaturized SPR imaging system of claim 1, wherein the light source and the detector are adjustable at least linearly along one direction and angularly along the optical axis of the miniaturized SPR imaging system.

16. The miniaturized SPR imaging system of claim 1, wherein the light source comprises an element selected from a group consisting of an LED, an incandescent source, a fluorescent source, and a laser source.

17. The miniaturized SPR imaging system of claim 1, wherein the incident angle of the light from the light source on the sensor substrate is adjustable.

18. The miniaturized SPR imaging system of claim 17, wherein the light source is configured to selectively emit illumination light from two or more locations along a line perpendicular to the optical axis of the miniaturized SPR imaging system, to thereby adjust the incident angle of the light on the sensor substrate.

19. The miniaturized SPR imaging system of claim 1, further comprising a window element provided on the side of the sensor substrate that faces an aqueous sample.

20. A miniaturized Surface Plasmon Resonance (SPR) imaging instrument, comprising:
a miniaturized SPR imaging system comprising: (i) a light source; (ii) a sensor substrate arranged to receive light at an incident angle from the light source; (iii) a detector for detecting an image from the sensor substrate; and (iv) a folded light path structure arranged between the light source and the detector and including the sensor substrate, the folded light path structure being configured so as to receive the light from the light source, to redirect the received light to be incident on the sensor substrate at the incident angle (first redirection), and to further redirect the light reflected from the sensor substrate toward the detector (second redirection);
a case housing the miniaturized SPR imaging system therein such that the sensor substrate is exposed to the outside of the case;
an electronic board housed in the case for controlling the operation of the SPR imaging instrument;
a microfluidic card configured to be positioned adjacent to the exposed sensor substrate so as to subject an aqueous sample flowing therethrough to SPR imaging; and
a computer including a user interface to guide a user through the operation of the SPR imaging instrument and image processing and analysis software.

21. The miniaturized SPR instrument of claim 20, wherein the microfluidic card comprises a window layer, a resonant layer formed on the window layer, and a flow layer formed on the resonant layer including fluid paths for the aqueous sample.

22. The miniaturized SPR instrument of claim 21, wherein the microfluidic card is further configured to be mated with external fluidics for inputting and outputting the aqueous sample.

23. The miniaturized SPR instrument of claim 22, wherein the electronic board is further configured to control the operation of the external fluidics.

24. The miniaturized SPR imaging instrument of claim 20, further comprising means for stabilizing the internal temperature of the case.

25. The miniaturized SPR imaging instrument of claim 20, wherein the image processing and analysis software is configured to carry out hyperspectral image processing.
